(19) United States
(12) Patent Application Publication
(10) Pub. No.: US 2013/0138487 A1
(43) Pub. Date: May 30, 2013

(54) DISTRIBUTING CONTENT

(71) Applicants: Marcel Crasmaru, Brockley (GB); Atul Bhandari, Sunnyvale, CA (US); Maxim Drobintsev, Sunnyvale, CA (US)

(72) Inventors: Marcel Crasmaru, Brockley (GB); Atul Bhandari, Sunnyvale, CA (US); Maxim Drobintsev, Sunnyvale, CA (US)

(73) Assignee: Google Inc., Mountain View, CA (US)

(21) Appl. No.: 13/513,325

(22) PCT Filed: Dec. 2, 2010
(86) PCT No.: PCT/US10/58710

§ 371 Date: Feb. 12, 2013

Related U.S. Application Data
(60) Provisional application No. 61/265,954, filed on Dec. 2, 2009.

(51) Int. Cl. G06F 17/30

(52) U.S. Cl. CPC G06F 17/30424; G06Q 30/0241
USPC 705/14.4; 707/770

(57) ABSTRACT

Systems and processes are provided for reviewing content items selected for distribution to content distribution slots. A publisher associated with a content distribution slot can search for content items that have selected attributes, review the content items, and select whether a content item is approved for distribution to the content distribution slot.

### CROSS-REFERENCE TO RELATED APPLICATION

This application claims priority to U.S. Provisional Application No. 61/265,954, filed on Dec. 2, 2009, and entitled “DISTRIBUTING CONTENT,” the entire contents of which are hereby incorporated by reference.

### TECHNICAL FIELD This disclosure relates to distributing content.

### BACKGROUND

In many different environments, content providers want to distribute content to selected recipients. For example, advertisers want to distribute their advertisements to advertisement slots where the advertisements will be effective in communicating information to potential customers, and when the advertisements will lead to desired activity, such as a purchase of the advertiser's goods or services. In some instances, a content provider may rely on contextual information when making decisions regarding content distribution slot selections. For example, an advertiser may want to advertise goods and/or services relating to travel in travel magazines, on travel web sites, or during travel television programs. In some instances, a content provider may rely on targeting information, such as demographic information of potential viewers, when making content distribution selections. Additionally, content providers can rely on performance information regarding results achieved by previous content distribution selections.

### SUMMARY

A publisher associated with a content distribution slot may not approve of a content item selected for distribution to the content distribution slot. For example, a publisher of a travel magazine that includes advertisement slots may not permit advertisements for competing travel magazines. Similarly, even where the publisher approves of the content provider of a particular content item that has been selected for distribution to the content distribution slot, the publisher may wish to review the content item to determine whether the content item is approved. For example, a publisher may wish to review a new content item to determine whether the content item includes any offensive material, whether the content item is composed in an acceptable format, or whether the content item should be approved or disapproved for any other reason. Through this review, the publisher can avoid exposing viewers of the publication to an offensive, incompatible, or otherwise unacceptable content item.

In another example, the publisher may wish to review previously-approved content items to locate and disapprove a content item that caused complaints from viewers. For example, if an individual objects to a content item distributed on a publisher's web site and submits a complaint to the publisher, the publisher may wish to locate the content item and disapprove the content item for further distribution on the publisher's web site. Additionally, the publisher may wish to locate other content items from the same content provider to verify that the other content items are acceptable.

A computer system for enabling publisher review of content items selected for distribution to content distribution slots provided by the publisher can facilitate such review of content items by the publisher. Particularly, a content item review system that includes a search function can allow a publisher to search for a particular content item, or for a group of content items, that have a selected attribute or combination of attributes. When the content items meeting the designated criteria are identified, only the identified content items are displayed to the publisher for review. Thus, the search function can allow the publisher to review only content items that are relevant to their search, whereby the publisher can avoid the need to manually find a content item from among all of the content items selected for distribution to content distribution slots included in the publisher's publications.

In one general implementation, managing content distribution includes receiving content information regarding content items for distribution and how the content items are to be distributed, receiving publication information regarding locations where content items are to be distributed, updating, by at least one processor based on the received content information and publication information, a searchable data structure that relates the content information and the publisher information, receiving a search query regarding content items that are related to at least one location where content is to be distributed, retrieving, by at least one processor from the data structure, content information responsive to the search query, and transmitting content information responsive to the search query to enable review of the content information.

Implementations may include one or more of the following features. For example, the content information can include one or more of content text information, content format information, content provider identification information, content distribution targeting information, location information regarding a location referenced by the content, and content review status information. The query can include one or more of content text information, content format information, content provider identification information, content distribution targeting information, location information regarding a location referenced by the content, and content review status information. Managing content distribution can further include receiving, after transmitting the content information, content review status information regarding approval or disapproval of identified content, and updating, by at least one processor, content review status information associated with the identified content in the data structure. Managing content distribution can further include receiving, in response to a corresponding change in a content delivery system, information regarding new content distribution information regarding a piece of content, and automatically updating, by at least one processor, the data structure. The data structure can automatically be updated to include a status identifier, the status identifier indicating that the new content information has not been reviewed by a publisher that publishes a location identified in the new content information. The search query can be received from a user interface, and the content information responsive to the search query can be transmitted to a publisher of a content distribution location through the user interface. The content can include advertising content.

In another general implementation a system for managing distributing content includes a receiver that receives content information regarding content items for distribution and how the content items are to be distributed. The receiver also receives publication information regarding locations where content items are to be distributed and search queries regarding content items that are related to at least one location where content is to be distributed. The system also includes at least one processor that updates a searchable data structure based on the received content information and publication information, where the searchable data structure relates the content information and the publisher information. At least one processor retrieves content information responsive to the search query from the searchable data structure, and a transmitter transmits the content information responsive to the search query to enable review of the content information.

Implementations may include one or more of the following features. For example, the content information includes one or more of content text information, content format information, content provider identification information, content distribution targeting information, location information regarding a location referenced by the content, and content review status information. The query includes one or more of content text information, content format information, content provider identification information, content distribution targeting information, location information regarding a location referenced by the content, and content review status information. After the content information is transmitted, the receiver receives content review status information regarding approval or disapproval of identified content, and at least one processor updates content review status information associated with the identified content in the data structure. In response to a corresponding change in a content delivery system, the receiver receives information regarding new content distribution information regarding a piece of content, and wherein the at least one processor automatically updates the data structure based on the new content distribution information. At least one processor automatically updates the data structure to include a status identifier, the status identifier indicating that the new content information has not been reviewed by a publisher that publishes a location identified in the new content information. The system can also include a user interface that transmits the search query, and the content information responsive to the search query is transmitted to a publisher of a content distribution location through the user interface. The content can include advertising content.

In another general implementation, managing advertisement distribution includes providing a user interface to a publisher of content, the content including an advertisement slot, receiving, through the user interface, a search query regarding advertisements targeted for distribution with the content of the publisher, the search query including advertisement information, selecting, by at least one processor and based on the advertisement information included in the search query, less than all advertisements targeted for distribution with the content of the publisher, transmitting information regarding the selected advertisements to the publisher through the user interface and in response to the search query, and receiving, through the user interface, advertisement status information that indicates whether an identified advertisement has been approved for distribution with the content of the publisher.

Implementations may include one or more of the following features. For example, the advertisement information included in the search query includes one or more of advertisement text information, advertisement format information, advertiser identification information, advertisement targeting information, location information regarding a location referenced by the content, and content review status information. Managing advertisement distribution can also include preventing distribution of an advertisement with the publisher's content based on advertisement status information associated with the advertisement.

The details of one or more implementations are set forth in the accompanying drawings and the description below. Other features will be apparent from the description and drawings, and from the claims.

### DESCRIPTION OF DRAWINGS

FIG. 1 is a diagram illustrating a system for managing distribution of advertising content.

FIG. 2 is a diagram illustrating system for distributing advertising content.

FIG. 3 is a diagram of a computer system operable in the system of FIG. 2.

FIG. 4 is a diagram illustrating a process for managing content distribution.

FIG. 5 is a diagram illustrating a process for distributing content.

FIG. 6 is a diagram illustrating an output of a user interface.

Like reference symbols in the various drawings indicate like elements.

### DETAILED DESCRIPTION

Many publishers include content provided by third party content providers in publications under the publisher's control. For example, newspaper publishers include advertisements, called creatives, provided by advertisers, and syndicated columns provided by independent columnists. Before publishing third party content items, a publisher may wish to review the content items to determine whether the content items are acceptable.

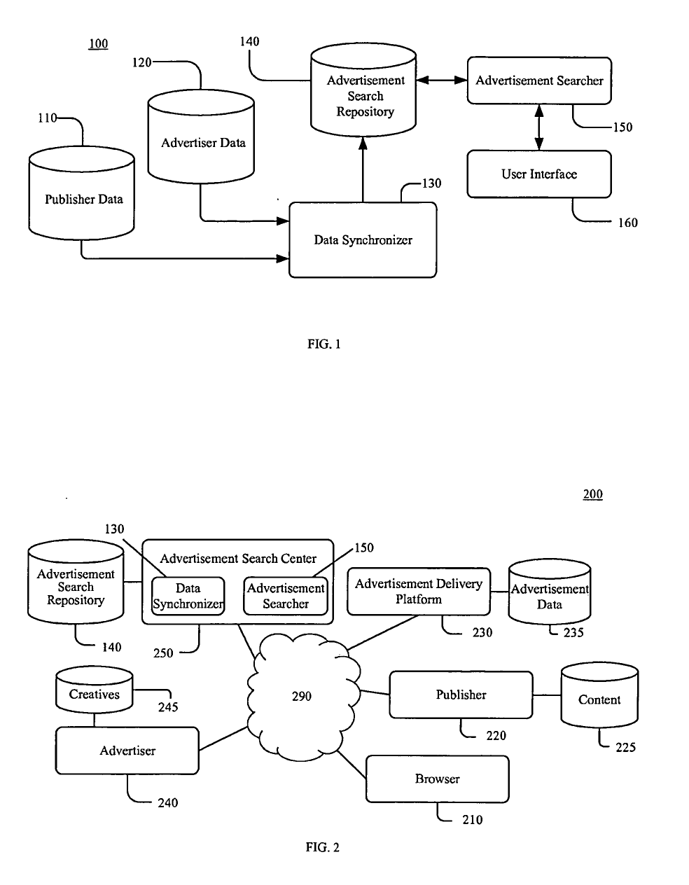

Referring to FIGS. 1 and 2, in an example environment in which the content items are advertisements, a publisher of a web site, such as the publisher 220, may include advertisement slots in one or more web pages of the web site. The advertisement slots are purchased by advertisers, such as the advertiser 240, for distribution of selected advertisements. For example, when an individual accesses a web page of the publisher 200 stored in a content repository 225 using a browser 210, an advertisement creative is displayed to the individual along with the publisher's content. An advertisement review system 100 allows the publisher to review advertisements that have been selected for distribution to the publisher's advertisement slots by advertisers who purchased the advertisement slots.

The advertisement review system 100 includes information about the publisher and the advertisement slots that are offered for sale, which is stored in a publisher data repository 110. Additionally, information about the advertisers who have purchased advertisement slots and the advertisements that the advertisers have selected for distribution to the advertisement slots is stored in an advertiser data repository 120. A data synchronizer 130 retrieves relevant data from the publisher data repository 110 and the advertiser data repository 120 to create and/or update an advertisement search repository 140.

For example, the data synchronizer 130 can retrieve, for each advertisement slot, information regarding the identity of a publisher selling the advertisement slot and information regarding the identity of advertisers that selected the advertisement slot for distribution of advertisements. The data synchronizer 130 can also retrieve information about the advertisement, including text information, target information, format information, status information, status change time information, and advertisement slot targeting information.

The data synchronizer 130 stores the retrieved information in a data structure maintained in the advertisement search repository 140, such as a distributed hash table. In some implementations, the advertisement search repository 140 can include an index for each publisher, or for each web site, and the only indexes searched are those associated with an account for which log-in credentials have been provided.

The data synchronizer 130 can retrieve the information from advertisement distribution setting information, advertisement slot offer information, and/or historical advertisement distribution information. For example, for advertisement slot reservations that dictate which advertisements will be distributed to a particular advertisement slot, or group of advertisement slots, this information can be retrieved from an advertisement distribution system that manages or implements the advertisement distribution, such as a system that selects advertisements in response to advertisement requests that are generated when an impression of the web page is rendered by a web browser. Additionally, or alternatively, logs or other historical information regarding historical distribution of advertisements to advertisement slots can be used to identify pairings between advertisements and advertisement slots. For example, an advertisement may be selected for distribution to a particular advertisement slot based on content targeting or viewer profile targeting. In some situations, such as where targeting is based on the viewer's profile, it may not be practical to identify the match between the advertisement and the advertisement slot in advance. Thus, the historical information can be used to supplement direct advertisement slot targeting information.

The text information retrieved by the data synchronizer 130 includes information regarding a text component of the advertisement or a script of a speech component of the advertisement. For example, the text information can include all of the terms and phrases that appear in the advertisement. Additionally, the text information can include information regarding text of a title of the advertisement, closed captioning information for a video advertisement, and keywords that relate to the advertisement.

The target information includes information regarding a navigational destination of the advertisement. For example, the target information can include information regarding a landing page address of a link included in the advertisement, such as the home page of an advertiser, or a product information page for an advertised product. The target information can also include information regarding another navigational target associated with the advertisement, such as a target email address or phone number to which a viewer of the advertisement is directed.

The format information includes information regarding a format of the advertisement. For example, the format information can include information regarding whether the advertisement includes text-only, audio, or video. Additionally, the format information can include information regarding the file type of the advertisement creative.

The status information includes information regarding whether the advertisement has been reviewed. Additionally, the status information can indicate whether the advertisement has been approved or disapproved. The status information can also include information regarding whether the advertisement is new. For example, the advertisement can be designated as new for a predetermined period of time after it has been selected for distribution to an advertisement slot. During the predetermined period, the advertisement may not be distributed to the advertisement slot unless the advertisement has been reviewed and approved. Then, after the predetermined period has expired, the advertisement will no longer be designated as new, regardless of the approval status, and distribution of the advertisement to the advertisement slot will commence.

The status time change information includes information regarding the last time that the status of the advertisement was changed. For example, a time that the advertisement was added as new can be indicated upon addition, and will persist until the advertisement is reviewed, or the predetermined period has expired. After review, the status time change information can indicate the time when the advertisement was approved or disapproved.

The advertisement slot targeting information includes information regarding criteria by which the advertisement was matched with the advertisement slot. For example, the advertisement slot targeting information can indicate that the advertisement was matched with the advertisement slot using direct advertisement slot targeting, in which an advertiser selects the advertisement slot directly. Alternatively, the advertisement slot targeting information can indicate that the advertisement was matched with the advertisement slot using content targeting, in which an advertisement is paired with the advertisement slot based on the current content of the web page or web site that includes the advertisement slot. As another alternative, the advertisement slot targeting information can indicate that viewer profile targeting was used, in which the advertisement is paired with the advertisement slot based on demographic information, preference information, or historical activity information associated with a viewer requesting an impression of the web page.

Other information can also be retrieved by the data synchronizer 130. For example, the data synchronizer 130 can retrieve a copy of each advertisement selected by the advertisers for distribution to the advertisement slot. Alternatively, information sufficient for subsequent retrieval of a copy of the advertisements can be retrieved. For example, if a video advertisement has been selected for distribution to the advertisement slot, the data synchronizer 130 can retrieve a thumbnail image associated with the video advertisement and a link that is operable to access a playable copy of the video advertisement. Alternatively, a copy of the video advertisement can be stored in the advertisement search repository 140 along with the thumbnail image. Additionally, selected information can be retrieved from stored historical advertisement distribution information. For example, information regarding a number of times that an advertisement has been distributed to a given advertisement slot can be retrieved, as can information regarding a total amount of revenue received from the distribution of the advertisement to the advertisement slot. As discussed in greater detail below, this information can be used in generating a search results display, either by incorporation of the information in the display or by organizing the information included in the display. For example, the copy of the advertisement can be included in the display, and the historical information can be used to sort advertisements that match a query, such as where the most profitable advertisements are displayed first.

An advertisement searcher 150 is operable to search through the information stored in the advertisement search repository 140 for information that is responsive to a search query received from a user interface 160. For example, the publisher 220 can access the user interface 160 and compose a search query by selecting one or more attributes of advertisements or advertisement slots. The attributes can include, for example, attributes regarding any of the publisher information, the advertisement slot information, the advertiser information, or the advertisement information discussed above. For example, the publisher can compose a search query by selecting a particular format of advertisements, such as video advertisements, by selecting a status identifier, such as new advertisements, or by selecting a combination of attributes. The user interface 160 transmits the search query to the advertisement searcher 150, which then retrieves information regarding advertisements that match one or more of the selected attributes. The retrieved information is then provided to the publisher 220 through the user interface 160 so that the publisher 220 can review the information.

In some implementations, such as in the system 200, the publisher data and the advertiser data can be maintained in an advertisement data repository 235 of an advertisement delivery platform system 230 that facilitates the sale of advertisement slots and that facilitates the distribution of advertisements. For example, the advertisement delivery platform system 230 can be or include a system like the AdSense system operated by Google Inc. The advertisement delivery platform system 230 is operable to receive a request for one or more advertisements in response to a request from the browser 210 to view content, such as a web page, stored in the content repository 225. In response to the request for advertisements, the advertisement delivery platform system 230 selects advertisements based on the requested content and/or the individual requesting the content, and transmits the selected advertisements for display by the browser 210.

The advertisement data repository 235 may include additional material that is not necessary for review of the advertisements, such as information regarding historical advertisement distribution activity, billing information, or other information regarding the operation of the advertisement delivery platform system 230. Additionally, some information can be stored separately from the advertisement data repository 235, such as copies of advertisement creatives stored in an advertisement creative repository 245. Thus, the data synchronizer 130 can retrieve information to create or update the advertisement search repository 140 by communicating with the advertisement data repository 235, the advertisement creative repository 245, and/or the content repository 225 of the publisher 220 over a network 290, such as the Internet.

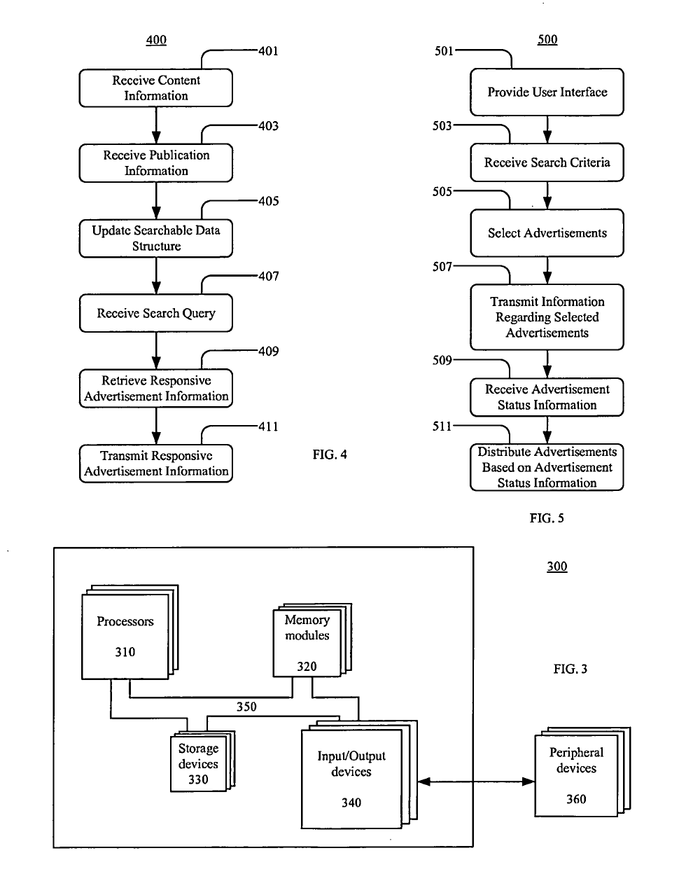

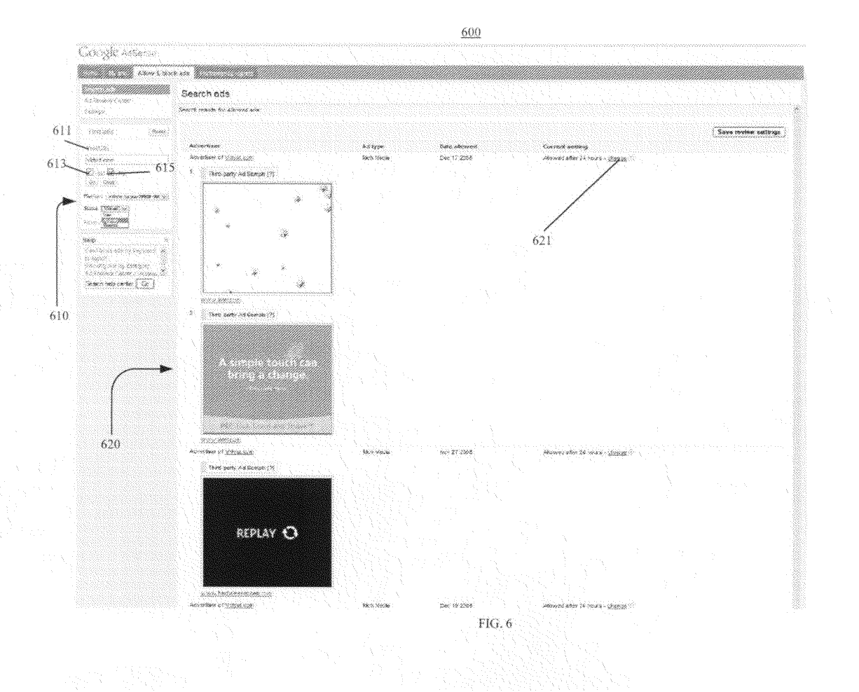

Referring also to FIG. 3, one or more of the components of the systems 100 and/or 200, such as the data synchronizer 130, the advertisement searcher 150, or the advertisement delivery platform 230, can include one or more computer systems, such as the computer system 300 of FIG. 3. The computer system 300 includes one or more processors 310, memory modules 320, storage devices 330, and input-output devices 340 connected by a system bus 350. The input-output devices 340 are operable with one or more peripheral devices 360, including a communication device that is operable to communicate with the network 290 and with the other components of the systems 100 and/or 200. The one or more computer systems 300 can perform the various functions of the components of the systems 100 and 200 by executing computer-readable instructions embodied in computer software stored on a computer-readable storage device, such as the memory modules 320, the storage devices 330, and/or the peripheral devices 360.

In use, the advertisement review system 100 can perform a process 400, illustrated in FIG. 4, for managing content distribution by allowing a publisher to review selected content items and approve or disapprove distribution of the content items to a content distribution slot. As discussed above, the data synchronizer 130 receives, for each content distribution slot, content information about the content items selected for distribution to advertisement slots and content information about the content providers that provided the content items (401). The data synchronizer 130 also receives publication information about the publisher and publication information about the content distribution slot (403).

In the advertising example discussed above, the data synchronizer 130 can receive advertisement information, advertiser information, publisher information, and advertisement slot information from the advertisement data repository 235 of the advertisement delivery platform system 230 over the network 290. For example, the data synchronizer 130 can receive, from the advertisement data repository 235, information about the identity of a publisher, such as a publisher identifier, information about the identity of advertisers, such as advertiser identifiers, information about the web page that includes the advertisement slot, such as an advertisement slot identifier, and information about the advertisements selected for distribution to the advertisement slot, such as advertisement identifiers. These identifiers can be arbitrary alpha-numeric values, and/or can be related to other information, such as the web page that includes the advertisement slot, and the names of the advertiser and publisher. Optionally, indications of these relationships can be maintained in a data structure stored on a storage medium. The data synchronizer 130 can also receive information about the text included in the advertisement, the address of the landing page of a link associated with the advertisement, information regarding the advertisement targeting method used, and a copy of the advertisement

In some implementations, the information can be stored in the form of keys and values in a distributed hash table. For example, the keys can include the advertisement slot identifier that identifies the specific slot on a specific web page, a status identifier that indicates whether the advertisement has been reviewed or not, and, if reviewed, whether approved or not, and the advertisement identifier which identifies a unique advertisement. If an advertisement is targeted for distribution in a group with other advertisements, then the information about the advertisements, such as the advertisement identifier can include information about an advertisement group to which the advertisement belongs. For example, an advertiser can group several advertisements for a single product into a group, and select advertisement slots to which any of the advertisements in the advertisement group can be distributed. The advertisement identifier for each of the advertisements in the advertisement group can include information that identifies the advertisement as a member of the advertisement group.

Similarly, if the advertisement slots are made targetable as a group, then the information about the advertisement slot can include information regarding an advertisement unit that includes the advertisement slot. For example, a publisher may group advertisement slots on several web pages of the publisher's web site where each of the advertisement slots has the same position on the page, or where all of the advertisement slots accept the same type or size of advertisement. The advertisement slot identifier for each advertisement slot in the advertisement unit can include information that indicates that the advertisement slot is a member of the advertisement unit.

The values can include the full text of the advertisement, the address of a landing page of a link included in the advertisement, the advertiser identifier, the targeting method type, and a time of the most recent status change. Thus, when an advertiser first selects to distribute a particular advertisement to a particular advertisement slot, the data synchronizer 130 retrieves the information of the keys and the values and updates the advertisement search repository 140 (405). Similarly, when an advertiser decides to cease distribution of an advertisement to the advertisement distribution slot, the data synchronizer 130 retrieves information regarding the cessation of distribution of the advertisement and can remove keys and values relating to the advertisement.

In the case of a new match between an advertisement and an advertisement slot, the status identifier can indicate that the advertisement is new and has not been reviewed. In some implementations, a new advertisement is prevented from being distributed for a predetermined period of time, such as 24 hours, or for an indefinite period until the advertisement is reviewed and approved by the publisher. Thus, an indication of a time when the advertisement will be distributed, regardless of review status, may also be included in the advertisement search repository. Because the publisher may have only a limited time to review the advertisement before the advertisement will appear on the publisher's website, the data synchronizer can retrieve the information for a new advertisement in response to an alert or notification. For example, the advertisement delivery platform system 230 can generate an alert or notification whenever an advertiser places an advertisement in an advertisement slot, or after the advertisement is approved for distribution to the advertisement slot in the advertisement delivery platform system 130. Thus, the delay between the time when the advertisement delivery platform system 230 is updated to distribute a selected advertisement to an advertisement slot and a time when the advertisement search repository 140 is updated can be low.

After the advertisement search repository 140 has been created, publishers can review the advertisements selected for distribution to one or more of the publisher's advertisement slots by generating a search query using the interface 160. In some implementations, the interface 160 can include a web page 600 that includes a search area 610. For example, the search area 610 can include text input tools, check-box selection tools, drop-down selection tools, radio button selection tools, or other input tools, including speech recognition input tools.

In some implementations, each input tool is associated with one of the types of information included in the data structure of the advertisement search repository 140. For example, a text input field 611 can be used by the publisher to provide terms or phrases that appear in an advertisement that the publisher wants to review, such as an advertisement that is associated with a complaint of inappropriate content received from a viewer of the publisher's web page.

Additionally, check-boxes can be used to indicate what type of information can include the terms or phrases entered in the text input field. For example, a check-box for advertisement text 613 and a check box for advertisement landing page URL 615 can be toggled to select whether the terms and phrases input in the text entry field 611 should be used to find matching text in the advertisement text information and the advertisement target information, respectively.

When the publisher has selected the desired text terms and phrases, and has made all other desired selections in the search area 610, the publisher can submit a query to the advertisement searcher 150. In some implementations, the interface 160 generates the search query based on the terms and other criteria provided by the publisher. For example, the interface 160 can include additional search terms and phrases based on the terms and phrases supplied by the publisher.

When the advertisement searcher 150 receives the search query from the interface 160 (407), the advertisement searcher 150 identifies the advertisements that have information that matches the text terms and phrases and the other search criteria provided in the search query. The advertisement searcher 150 then retrieves information associated with the identified advertisements (409) and transmits the retrieved advertisement information to the interface 160 for display to the publisher (411).

For example, the web page 600 can include an area 620 for the display of search results. As illustrated, the area 620 can include a paged list of search results, where each item in the list is associated with a respective advertisement. The advertisements can be ranked according to frequency of display, amount of revenue generated for the publisher, alphabetically by advertiser, or according to other criteria, such as where the publisher ranks their advertisement slots (or advertisement units), and the advertisements are ranked according to the rank of the advertisement slot to which the advertisement is targeted. In some implementations, each item can include a thumbnail image, such as a thumbnail image of the image of a still graphic advertisement, or a thumbnail image of a representative frame of a video advertisement. Each item of the search results list can also include information regarding a format of the advertisement, status information, target information, such as the landing page URL, or other information retrieved from the advertisement search repository. Additionally, each item of the search results list can include a tool 621 for changing status information of an advertisement. For example, the tool 621 can be formed as a link that, when executed, causes the interface 160 to display a web page where a desired status can be input. Alternatively, activation of the link may toggle the status between approved and disapproved.

In some implementations, the interface 160 can be entirely implemented as an advertisement search center system 250 that includes a web site that is accessible by the publisher 220 via an Internet browser and the network 290. Thus, when a publisher wishes to search for advertisements in order to review the advertisements selected for distribution in an advertisement of the publisher's web site, the publisher can navigate to a web page address associated with the web site of the advertisement search center system 250 and request a copy of the web page. In response to the request, the interface 160 is provided to the publisher 220 in the form of a web page of the advertisement search center system 250 (501).

When the publisher 220 receives a copy of the interface 160, such as the web page 600, the publisher 220 can select desired search criteria in order to find one or more advertisements that meet the search criteria. For example, the publisher 220 can indicate that the publisher 220 only wishes to review advertisements that link to a selected advertiser's web site and that have not yet been reviewed. When the advertisement search center system 250 receives the selected search criteria (503), the advertisement search center system 250 selects the advertisements that have information that matches the selected search criteria (505). Thus, the advertisement search center system 250 can identify all of the advertisements in the advertisement search repository 140 that include a link to any page of the selected advertiser's web site that also include a status identifier that indicates that the advertisement has not yet been reviewed.

The advertisement search center system 250 then transmits the information associated with the selected advertisements to the publisher 220 (507). When the publisher 220 receives a display of the information associated with the selected advertisements, the publisher 220 can review the advertisement information, including review of copies of the selected advertisements. For example, the publisher 220 can activate a link associated with the thumbnail image of the advertisement to view the full advertisement image or video.

When the publisher 220 indicates through the interface 160 that an advertisement is approved or disapproved, the advertisement search center system 250 receives status information regarding the advertisement that corresponds to the publisher's indication (509). The advertisement search center system 250 then updates the advertisement search repository 140 to reflect the received status information and transmits a status information update message to the advertisement delivery platform system 230 such that the advertisement will be distributed to the publisher's advertisement slot if the publisher 220 approved the advertisement, and such that the advertisement will not be distributed to the publisher's advertisement slot if the publisher 220 disapproved the advertisement. The advertisement delivery platform system 230 then distributes advertisements to advertisement slots based, at least in part, on the status information regarding the approval or disapproval for each advertisement by the publisher of the advertisement slots (511).

While some implementations are described above, these should not be viewed as exhaustive or limiting, but rather should be viewed as exemplary, and included to provide descriptions of various features. It will be understood that various modifications may be made without departing from the spirit and scope of this disclosure. For example, the advertisement search repository 140 can include other types of data structures, such as a relational database. Additionally, the interface 160 can include a client computer program that is operable by the publisher 220 to review and approve or disapprove advertisements without using web pages. Additionally, while the search repository 140 has been described as being generated based on stored information regarding advance reservations of content distribution slots, the information can also include historical information, such as where auctions for advertisement to fill advertisement slots are conducted in real time in response to an advertisement request generated in rendering an impression of a web page to a browser. Hybrid systems can also be used, such as where the content distribution slot reservations compete with real-time third party bids, such as bids from advertisement networks, for each impression of the web page that includes the content distribution slot.

In some implementations, the advertisement search center system 250, or another similar system, can be used by brokers or re-sellers of advertisement slots, in addition to or instead of publishers, to review advertisements selected for distribution to the advertisement slots.

Additionally, although illustrated as separate, the advertisement search center system 250 and/or the advertisement review system 100 can be formed as one or more components of an advertisement delivery platform system. Thus, the advertisement search repository 140 and the advertisement data repository 235 can be linked or integrated in a common data structure, and publishers can use a common interface to review advertisements selected for distribution to their advertisement slots as well as other advertisement slot management functions, such as inventory grouping, price setting, and/or performance monitoring.

Accordingly, other implementations are within the scope of the following claims.

1. A computer-implemented method for managing content distribution, the method comprising:
receiving content information regarding content items for distribution and how the content items are to be distributed;
receiving publication information regarding locations where content items are to be distributed;
updating, by at least one processor based on the received content information and publication information, a searchable data structure that relates the content information and the publisher information;
receiving a search query regarding content items that are related to at least one location where content is to be distributed;
retrieving, by at least one processor from the data structure, content information responsive to the search query; and
transmitting content information responsive to the search query to enable review of the content information.

2. The computer-implemented method of claim 1, wherein the content information includes one or more of content text information, content format information, content provider identification information, content distribution targeting information, location information regarding a location referenced by the content, and content review status information.

3. The computer-implemented method of claim 1, wherein the query includes one or more of content text information, content format information, content provider identification information, content distribution targeting information, location information regarding a location referenced by the content, and content review status information.

4. The computer-implemented method of claim 1, further comprising receiving, after transmitting the content information, content review status information regarding approval or disapproval of identified content, and updating, by at least one processor, content review status information associated with the identified content in the data structure.

5. The computer-implemented method of claim 1, further comprising receiving, in response to a corresponding change in a content delivery system, information regarding new content distribution information regarding a piece of content, and automatically updating, by at least one processor, the data structure.

6. The computer-implemented method of claim 5, wherein the data structure is automatically updated to include a status identifier, the status identifier indicating that the new content information has not been reviewed by a publisher that publishes a location identified in the new content information.

7. The computer-implemented method of claim 1, wherein the search query is received from a user interface, and wherein the content information responsive to the search query is transmitted to a publisher of a content distribution location through the user interface.

8. The computer-implemented method of claim 1, wherein the content includes advertising content.

9. A system for managing distributing content, the system comprising:
a receiver that receives content information regarding content items for distribution and how the content items are to be distributed, that receives publication information regarding locations where content items are to be distributed, and that receives search queries regarding content items that are related to at least one location where content is to be distributed;
at least one processor that updates a searchable data structure based on the received content information and publication information, the searchable data structure relating the content information and the publisher information, and that retrieves content information responsive to the search query from the searchable data structure; and
a transmitter that transmits the content information responsive to the search query to enable review of the content information.

10. The system of claim 9, wherein the content information includes one or more of content text information, content format information, content provider identification information, content distribution targeting information, location information regarding a location referenced by the content, and content review status information.

11. The system of claim 9, wherein the query includes one or more of content text information, content format information, content provider identification information, content distribution targeting information, location information regarding a location referenced by the content, and content review status information.

12. The system of claim 9, wherein, after the content information is transmitted, the receiver receives content review status information regarding approval or disapproval of identified content, and wherein the at least one processor updates content review status information associated with the identified content in the data structure.

13. The system of claim 9, wherein, in response to a corresponding change in a content delivery system, the receiver receives information regarding new content distribution information regarding a piece of content, and wherein the at least one processor automatically updates the data structure based on the new content distribution information.

14. The system of claim.13, wherein at least one processor automatically updates the data structure to include a status identifier, the status identifier indicating that the new content information has not been reviewed by a publisher that publishes a location identified in the new content information.

15. The system of claim 9, further comprising a user interface, the user interface transmitting the search query, and wherein the content information responsive to the search query is transmitted to a publisher of a content distribution location through the user interface.

16. The system of claim 9, wherein the content includes advertising content.

17. A computer-implemented method for managing advertisement distribution, the method comprising:
providing a user interface to a publisher of content, the content including an advertisement slot;
receiving, through the user interface, a search query regarding advertisements targeted for distribution with the content of the publisher, the search query including advertisement information;
selecting, by at least one processor and based on the advertisement information included in the search query, less than all advertisements targeted for distribution with the content of the publisher;
transmitting information regarding the selected advertisements to the publisher through the user interface and in response to the search query; and
receiving, through the user interface, advertisement status information that indicates whether an identified advertisement has been approved for distribution with the content of the publisher.

18. The method of claim 17, wherein the advertisement information included in the search query includes one or more of advertisement text information, advertisement format information, advertiser identification information, advertisement targeting information, location information regarding a location referenced by the content, and content review status information.

19. The computer-implemented method of claim 17, further comprising preventing distribution of an advertisement with the publisher's content based on advertisement status information associated with the advertisement.
